(19) United States
(12) Patent Application Publication
(10) Pub. No.: US 2010/0061680 A1
(43) Pub. Date: Mar. 11, 2010

(54) RESETTABLE OPTICAL FUSE

(76) Inventors: Ram Oron, Rehovot (IL); Ariela Donval, Rosh-Ha'ain (IL); Boaz Nemet, Tel-Aviv (IL); Doron Nevo, Ra'anana (IL); Moshe Oron, Rehovot (IL)

Correspondence Address: NIXON PEABODY, LLP, 300 S. Riverside Plaza, 16th Floor, CHICAGO, IL, 60606, US

(21) Appl. No.: 12/525,105

(22) PCT Filed: Jan. 31, 2008
(86) PCT No.: PCT/IB08/00216

§ 371 Date: Nov. 11, 2009

Related U.S. Application Data
(60) Provisional application No. 60/898,526, filed on Jan. 31, 2007.

(51) Int. Cl. G02B 6/26

(52) U.S. Cl. 385/16; 385/39

(57) ABSTRACT

A resettable optical energy switching device comprises a waveguide forming an optical path between an input end and an output end, and an optical energy diverting material located in said optical path for diverting optical energy propagation away from said output end when said optical energy exceeds a predetermined threshold. The optical energy diverting material does not divert optical energy propagation away from the output end when the optical energy propagation drops below the predetermined threshold, and thus propagation of optical energy to the output end is automatically resumed when the optical energy drops below the predetermined threshold. In one implementation, the optical energy diverting material comprises a light-absorbing material having an index of refraction that decreases as light is absorbed by the material.

### FIELD OF THE INVENTION

The present invention relates to optical power switching devices and methods, and particularly to such devices and methods for interrupting or reducing the optical transmission in response to the transmission of excessive optical power or energy, having the ability to reset their parameters to the original value when power is below a switching threshold.

### BACKGROUND OF THE INVENTION

Fiber lasers, fiber optics for communication systems, and other systems for light delivery, such as in medical, industrial and remote sensing applications, often handle high levels of optical power, namely, up to several Watts in a single fiber or waveguide. When these high intensities or power per unit area are introduced into the systems, many thin film coatings, optical adhesives, bulk materials and detectors, are exposed to light fluxes beyond their damage thresholds and are eventually damaged. Another issue of concern in such high-power systems is laser safety, where well-defined upper limits are established for powers emitted from fibers. These two difficulties call for a passive device that will switch off the power propagating in a fiber or waveguide, when the power exceeds the allowed intensity. Such a switching device should be placed either at the input of a sensitive optical device, or at the output of a high-power device such as a laser or an optical amplifier, or integrated within an optical device.

In the past, there have been attempts to realize an optical safety shutter, sometimes called an optical fuse, mainly for high-power laser radiation and high-power pulsed radiation; special efforts were devoted to optical sights and eye safety devices. The properties on which these prior art solutions were based included: (1) self-focusing or self-defocusing, due to a high electric-field-induced index change through the third order susceptibility term of the optical material, and (2) reducing the optical quality of a gas or a solid transparent insert positioned at the cross-over spot of a telescope, by creating a light-absorbing plasma in the cross-over point. These are described in U.S. Pat. Nos. 3,433,555 and 5,017,769. U.S. Pat. No. 3,433,555 describes plasma that is created in a gas where the gas density is low (lower than solids and liquids) and the density of the plasma created by the gas is low as well, limiting its absorption to the medium- and far-infrared part of the light spectrum. This device is not absorbing in the visible and near-infrared regions and cannot protect in these regions of the spectrum. U.S. Pat. No. 5,017,769 describes the use of a solid insert in the crossover point. This transparent insert is covered with carbon particles on its surface, enhancing the creation of plasma on the surface at lower light intensities. The plasma density is high, since it starts from solid material. The dense plasma absorbs visible as well as infrared light, and the device is equipped with multiple inserts on a motorized rotating wheel that exposes a new, clean and transparent part after every damaging pulse. The two devices described above, namely U.S. Pat. Nos. 3,433,555 and 5,017,769, are large in their volume, work in free space and require high pulsed powers.

Passive devices were proposed in the past for image display systems. These devices generally contained a mirror that was temporarily or permanently damaged by a high-power laser beam that damaged the mirror by distortion or evaporation. Examples for such devices are described in U.S. Pat. Nos. 6,384,982, 6,356,392, 6,204,974 and 5,886,822. The powers needed here are in the range of pulsed or very energetic CW laser weapons and not in the power ranges for communication or medical devices. The distortion of a mirror by the energy impinging on it is very slow and depends on the movement of the large mass of the mirror as well as the energy creating the move. The process of removing a reflective coating from large areas is also slow, since the mirror is not typically placed in the focus where power is spatially concentrated. Another passive device was proposed in U.S. Pat. No. 621,658B1, where two adjacent materials were used. The first material was heat absorbing, while the second material was heat degradable. When these two materials were inserted into a light beam, the first material was heated and transferred its heat to the second material to degrade the transparency or reflectivity of the second material. This process was relatively slow, since heat transfer times are slow, and in many cases not sufficiently fast to interrupt a light beam before damage occurs to objects along the optical line. In addition, the process of temperature-induced degradation often does not provide enough opacity to efficiently prevent damage from high-power spikes that are a known phenomenon in laser-fiber amplifiers. An optical switching device, or an optical fuse, having fast rise times and sufficient attenuation is described in U.S. Patent Publication No. 2005/0111782; this device performs well but is a one-shot-device, needing replacement after every switching operation.

Better, automatically resettable, passive devices are needed. The present invention provides such a solution.

SUMMARY OF THE INVENTION In one embodiment, a resettable optical energy switching device comprises a waveguide forming an optical path between an input end and an output end, and an optical energy diverting material located in said optical path for diverting optical energy propagation away from said output end when said optical energy exceeds a predetermined threshold. The optical energy diverting material does not divert optical energy propagation away from the output end when the optical energy propagation drops below the predetermined threshold, and thus propagation of optical energy to the output end is automatically resumed when the optical energy drops below the predetermined threshold. In one implementation, the optical energy diverting material comprises a light-absorbing material having an index of refraction that decreases as light is absorbed by the material.

In a preferred embodiment, the optical energy diverting material extends across the optical path an acute angle relative to the longitudinal axis of the optical path. In one implementation, the optical energy diverting material comprises a suspension of light absorbing particles in a solid material having a a large negative dn/dT. The absorbing particles may be nano particles of at least one material selected from the group consisting of Ag, Au, Ni, Va, Ti, Co, Cr, C, Re, Si and mixtures thereof, and the solid material may be at least one transparent material selected from the group consisting of PMMA, derivatives of PMMA, epoxy resins, glass and SOG. The solid material may be in the form of a liquid or a gel.

A bulk material may be provided on opposite sides of the optical energy diverting material and having substantially the same dn/dT as the optical energy diverting material. In another implementation, the waveguide comprises a core and a cladding, and the optical energy diverting material extends into a portion of said cladding having substantially the same dn/dT as said optical energy diverting material. The cladding having substantially the same dn/dT as the optical energy diverting material may contain a core that forms a portion of the optical path having at least one transverse interface that forms an acute angle with a plane perpendicular to the longitudinal axis of the optical path.

In one specific embodiment, the optical energy diverting material is thermally responsive to optical energy. The optical energy diverting material comprises at least one layer of material that is transparent to optical energy below the predetermined threshold, and diverts all energies above the predetermined threshold. In one implementation, the optical energy diverting material comprises at least one layer of material that diverts energies above the predetermined threshold by total internal reflection (TIR).

### BRIEF DESCRIPTION OF THE DRAWINGS

The invention will be better understood from the following description of preferred embodiments together with reference to the accompanying drawings, in which:

FIG. 1 is a schematic view of an optical resettable optical fuse without temperature compensation.

FIG. 2 is a schematic view of an optical resettable optical fuse with temperature compensation.

FIG. 3 is a schematic view of an optical resettable optical fuse with temperature compensation and adjacent waveguide for low loss.

FIG. 4 is a schematic view of an optical resettable optical fuse with temperature compensation, adjacent waveguide for low loss and angled input for low reflection

FIG. 5 is a schematic view of an optical resettable optical fuse with temperature compensation, and lenses for wave guiding.

FIG. 6 is a schematic view of an optical resettable optical fuse with temperature compensation, and adjacent waveguide for low loss in an alignment sleeve.

FIG. 7 is an output vs. input curve of an optical resettable optical fuse.

### DETAILED DESCRIPTION OF PREFERRED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

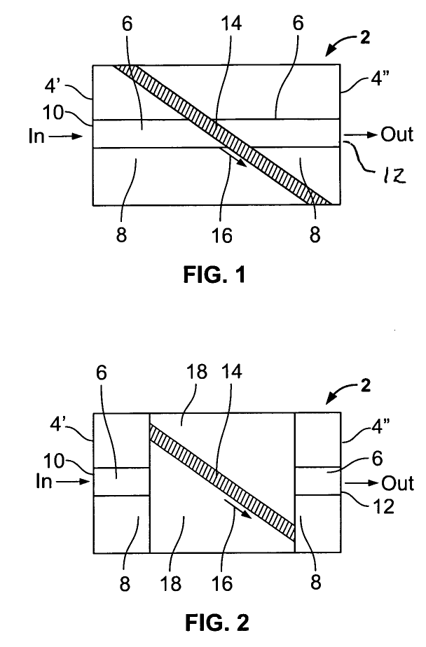

Referring now to FIG. 1, there is shown a resettable optical power or energy switching device 2, composed of a waveguide 4, e.g., a solid waveguide or a fiber. The waveguide is composed of a central core 6, in which most of the light propagates, and an outer cladding 8. Also, the waveguide has an input end 10 and an output end 12. Interposed between two end portions 4′ and 4″ of waveguide 4 and transversing the propagation path of optical energy from input end 10 to output end 12, there is affixed an optical energy diverting layer 14. The layer 14 is typically angled to the propagation direction of the light in the waveguide. Layer 14 may be made of material where the index of refraction is changed due to light absorption in it.

The layer 14 is preferably a thin, substantially transparent, partially absorbing, layer of nano-structure material disposed between the opposed surfaces of the input and output waveguide sections, at an acute angle to the longitudinal axis of the optical path. The nano-structure material heats up when exposed to optical signals propagating within the optical waveguide with an optical power level above a predetermined threshold, the change in temperature causes a change dn/dT in the index of refraction of the nano-structure, creating total internal reflection and thus deviation of the light propagating within the optical waveguide so as to prevent the transmission of such light to the output 12.

The light-absorbing nano-structure can use light-absorbing nano particles dispersed in a transparent matrix such as a monomer, which is subsequently polymerized. There are several techniques for preparing such dispersions, such as with the use of dispersion and deflocculation agents added to the monomer mix. One skilled in the art of polymer and colloid science is able to prepare this material for a wide choice of particles and monomers.

When light is absorbed in layer 14 it heats up and the index of refraction is changed (absorbing, e.g., 10% at 1550 nm or other spectral regions). The optical material in 14 is either absorbing by itself or is composed of a suspension of light absorbing particles, smaller than the wavelength of visible light (about 5 to 10 nm in size) equally distributed or suspended in a solid, e.g., polymer, material having a large index change with temperature (dn/dT). The absorbing nano particles are, e.g., metallic or non-metallic materials like Ag, Au, Ni, Va, Ti, Co, Cr, C, Re, Si and mixtures of such materials. The polymer host material, having a large, negative (dn/dT), may be: PMMA or its derivatives, epoxy resins, glass, SOG or other transparent materials as gels and liquids. When the light power through layer 14 is up to a predetermined threshold power, the index of refraction of layer 14 is reduced compared to the index of core 6 in an amount creating total internal reflection (TIR) in the interface of core 6 and layer 14, diverting the power into the layer 14 in the direction 16, where it is absorbed by the outer cladding 8 and does not propagate to the output 12. When the propagating power is reduced below threshold, the difference between the index of layer 14 and that of the core 6 is reduced, thus resuming the propagation of light toward the output 12.

FIG. 2 illustrates a similar device as shown in FIG. 1. However, here the diverting layer 14 is immersed in both sides in a bulk 18 of material that has the same index change with temperature (dn/dT) as the layer 14, but preferably without the absorbing particles. This configuration compensates for index changes which are due to ambient temperature changes. Since both materials 14 and 18 have identical index changes with temperature (dn/dT), their interface is not affected by ambient temperature change.

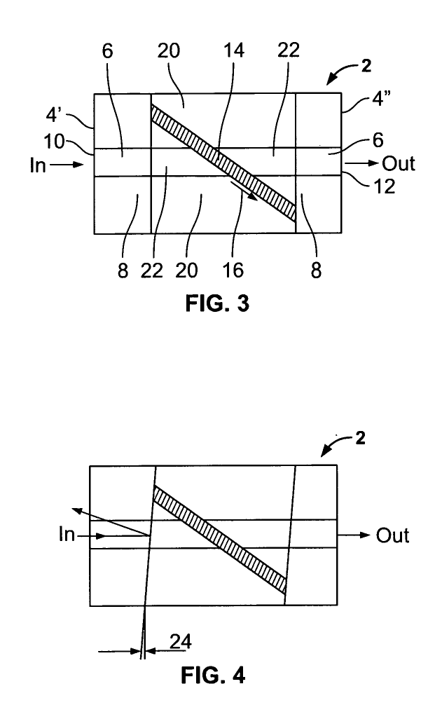

FIG. 3 illustrates a similar device as shown in FIG. 2. However, here the diverting layer 14 is immersed in both sides in a bulk core 22 and bulk cladding 20, which maintain the wave guiding properties. Core 22 comprises a material having the same index change with temperature (dn/dT) as the layer 14, but without the absorbing particles. This configuration compensates for index changes which are due to ambient temperature changes. Since both materials 14 and 22 have identical index changes with temperature (dn/dT), their interface is not affected by external temperature change. The cladding 20 is made of material having a slightly lower index than core 22, for wave guiding, but with the same index change with temperature (dn/dT) as layer 14 and core 22, preferably without the absorbing particles.

FIG. 4 illustrates a similar device as shown in FIG. 3. However, here the diverting layer 14 is immersed in both sides in a bulk core 22 and bulk cladding 20 which are cut in an angle 24 (e.g., 8 degrees) to lower the back reflection into the input core.

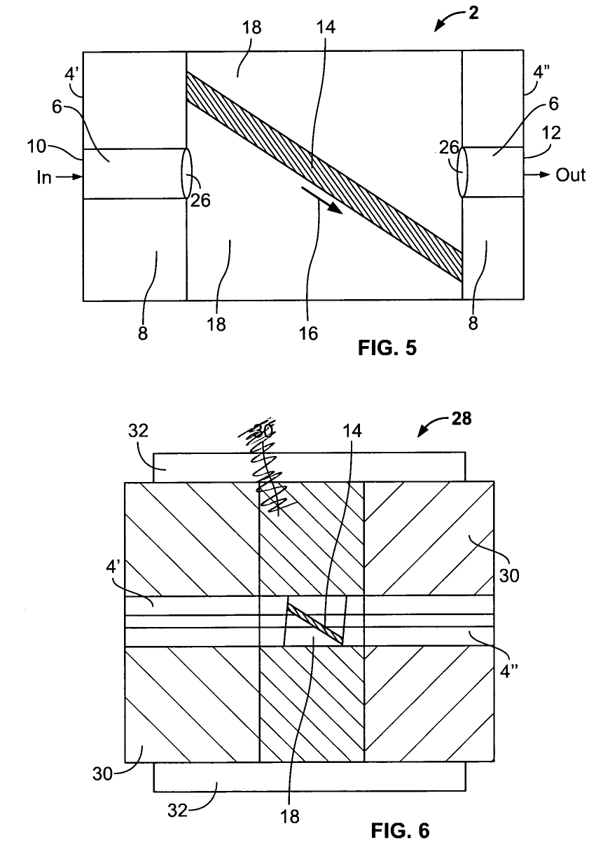

FIG. 5 is a schematic view of an optical resettable optical fuse with temperature compensation, as in FIG. 2, with the addition of two lenses 26 for wave guiding of the light in the bulk 18.

FIG. 6 is a schematic view of an optical resettable optical fuse 28 with temperature compensation, having adjacent waveguides 18 for low loss, and assembled into two ferrule assemblies 30, on the input and output sides, in an alignment sleeve 32.

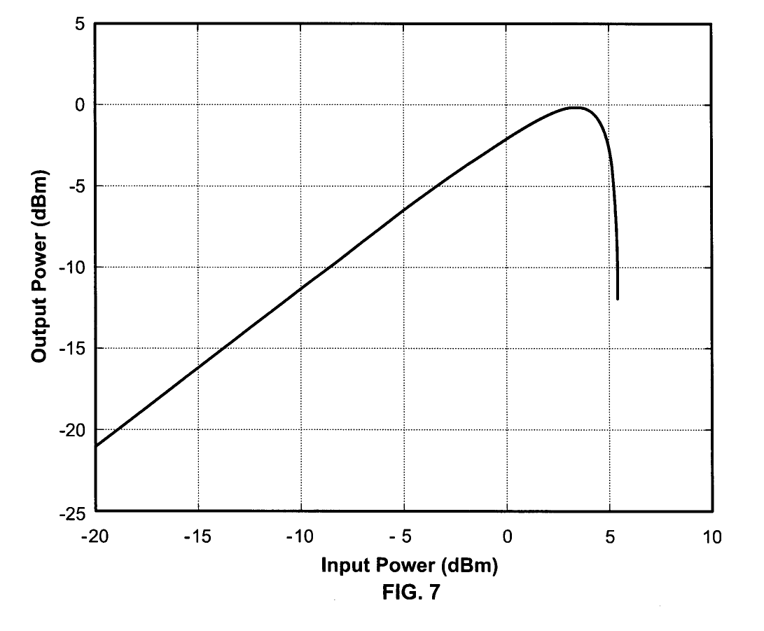

FIG. 7 is an output vs. input curve of an optical resettable optical fuse. The parameters are as follows: incidence angle is 83.6° (calculated according to the critical angle for total internal reflection), refraction index of film 14 is n_{Film}=1.455, refraction index of core glass is n_{Glass}=1.460, the thickness of layer 14 is 30 micrometers and its absorption coefficient is α=50 cm⁻¹. The curve shows a resettable fuse for 0 dBm or 1 mw of optical power.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

1. A resettable optical energy switching device, comprising: a waveguide forming an optical path between an input end and an output end, and an optical energy diverting material located in said optical path for diverting optical energy propagation away from said output end by TIR when said optical energy exceeds a predetermined threshold.

2. The resettable optical energy switching device of claim 1 in which said optical energy diverting material does not divert optical energy propagation away from said output end when said optical energy propagation drops below said predetermined threshold.

3. The resettable optical energy switching device of claim 1 in which said optical energy diverting material comprises a light-absorbing material having an index of refraction that decreases as light is absorbed by said material.

4. The resettable optical energy switching device of claim 1 in which said optical energy diverting material extends across said optical path an acute angle relative to the longitudinal axis of said optical path.

5. The resettable optical energy switching device of claim 4 which includes a bulk material on opposite sides of said optical energy diverting material and having substantially the same dn/dT as said optical energy diverting material.

6. The resettable optical energy switching device of claim 1 in which said waveguide comprises a core and a cladding, and said optical energy diverting material extends into a portion of said cladding having substantially the same dn/dT as said optical energy diverting material.

7. The resettable optical energy switching device of claim 1 in which said waveguide has a cladding with substantially the same dn/dT as said optical energy diverting material, and a core that forms a portion of said optical path with at least one transverse interface that forms an acute angle with a plane perpendicular to the longitudinal axis of said optical path.

8. The optical energy switching device as claimed in claim 1 wherein said optical energy diverting material is thermally responsive to optical energy.

9. The optical energy switching device of claim 1 in which said optical energy diverting material is transparent to optical energy below said predetermined threshold.

10. (canceled)

11. The optical energy switching device of claim 1 wherein said_optical energy diverting material comprises a suspension of light absorbing particles in a solid material having a large negative dn/dT.

12. The optical energy switching device of claim 11 in which said absorbing particles are nano particles of at least one material selected from the group consisting of Ag, Au, Ni, Va, Ti, Co, Cr, C, Re, Si and mixtures thereof.

13. The optical energy switching device of claim 11 in which said solid material is at least one transparent material selected from the group consisting of PMMA, derivatives of PMMA, epoxy resins, glass and_SOG.

14. (canceled)

15. A method of controlling the propagation of optical energy along an optical path between an input end and an output end of an optical waveguide, said method comprising diverting the propagation of said optical energy away from said output end in response to an increase in said optical energy to a predetermined threshold, and automatically resuming the propagation of said optical energy to said output end in response to a decrease in said optical energy below said predetermined threshold.

16. The method of claim 15 in which said optical energy is diverted by a light-absorbing material having an index of refraction that decreases as light is absorbed by said material.

17. The method of claim 16 in which said optical energy diverting material extends across said optical path to divert said optical energy away from said optical path at an acute angle relative to the longitudinal axis of said optical path.

18. The method of claim 16 which includes compensating for temperature variations by disposing a bulk material on opposite sides of said light-absorbing material, said bulk material having substantially the same dn/dT as said light-absorbing material.

19. The method of claim 16 which includes compensating for temperature variations by disposing said light-absorbing material in a cladding having substantially the same dn/dT as said light-absorbing material.
